(19) United States
(12) Patent Application Publication
(10) Pub. No.: US 2009/0207918 A1
(43) Pub. Date: Aug. 20, 2009

(54) METHOD AND APPARATUS FOR VIDEO TRANSCODING

(76) Inventors: Gaosheng FAN, Shenzhen (CN); Jun Yan, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/432,218

(22) Filed: Apr. 29, 2009

Related U.S. Application Data
(63) Continuation of application No. PCT/CN2008/000135, filed on Jan. 18, 2008.

(30) Foreign Application Priority Data
Jan. 19, 2007 (CN) 200710001164.6

(51) Int. Cl. H04N 7/24

(52) U.S. Cl. 375/240.23; 375/E07.021

(57) ABSTRACT

The present embodiments disclose methods and apparatus for transcoding video data. A method for transcoding video data may include: performing variable length decoding on an input bit stream; determining a bit stream part that can be transmitted transparently and a bit stream part that cannot be transmitted transparently according to an original compression protocol, a target compression protocol, and relevant bit stream parameters; decompressing the bit stream part that cannot be transmitted transparently according to the original compression protocol and compressing the decompressed bit stream according to the target compression protocol; combining the bit stream part that can be transmitted transparently and the compressed bit stream part that cannot be transmitted transparently; and performing variable length coding on the combined bit stream to generate an output bit stream. This greatly decreases the calculation workload of the transcoder, speeds up transcoding, and ensures real-time image transmission.

### CROSS REFERENCE TO RELATED APPLICATIONS

This application is a continuation of international application number PCT/CN2008/000135 filed on Jan. 18, 2008, which claims the priority of the Chinese patent application No. 200710001164.6 titled “Method and apparatus for video transcoding”, filed on Jan. 19, 2007, the contents of both of which are incorporated herein by reference in their entirety.

### TECHNICAL FIELD

The present invention relates to the computer and communication fields, and in particular, to a method and apparatus for video transcoding.

### BACKGROUND

At present, video coding and decoding technologies are widely applied to digital TV, videoconferencing, and Internet video transmission. Different application fields have different requirements for video coders, video decoders, video data storage formats, and network transmission devices. Thus, different coding and decoding standards are formulated. For example, the MPEG-2 codec standard is oriented to digital TV; the H.263 and H.264 codec standards are oriented to videoconferencing; and the MPEG-4 standard (a super low bit rate codec standard) is oriented to mobile multimedia applications.

To support seamless connection between heterogeneous networks, access devices, and multimedia data formats, the prior art uses a video transcoding technology. The video transcoding technology is used to decode compressed video streams (one or more encoded data streams), zoom in/out, edit, or combine decoded images, encode the processed images for the second time, and then output the images. The video transcoding technology is widely applied. For example, in a video on demand (VOD) system, people can request VOD services in wireless mode after installing a transcoder on the VOD server. In a video surveillance system, remote surveillance can be implemented through the Internet after the data of scenes is processed by the transcoder. In a videoconferencing system, a multi-point control unit performs transcoding to combine images and convert protocol/image formats. In the digital TV broadcast field, to ensure that any multimedia terminal can receive digital broadcast signals, a device similar to a set top box (STB) or media gateway performs transcoding on relevant data such as the bit rate and the resolution.

Prior transcoders are classified into three types: open-loop transcoder, cascade pixel domain transcoder, and discrete cosine transform transcoder. The following takes the cascade pixel domain transcoder as an example. As shown in FIG. 1, the cascade pixel domain transcoder includes a decoding module, a motion vector (MV) mapping module, and a coding module. When a compressed bit stream is input, the transcoder transcodes it as follows:

Step 100: The transcoder performs variable length decoding (VLD) on the compressed bit stream.

The compressed bit stream includes a key video frame (I frame) and predictive video frames (P frame and B frame). The I frame stores complete video data of an image. The P and B frames are used to adjust the corresponding I frame to obtain new images.

For convenient transmission, the video data in the I frame is divided into several unit image blocks and each block is called an I block. Each I block contains corresponding macroblock information that is used to record the macroblock type, macroblock identifier, and macroblock size for the I block. In the same way, the video data in the P or B frame is also divided into several unit image blocks and each block is called a P or B block. Each P or B block contains corresponding macroblock information that is used to record the macroblock type, macroblock identifier, macroblock size, MV, and quantitative information for the P or B block. In addition, the P or B frame may contain the I block to carry corresponding video data. A unit image block can be divided as required, which is not restricted by the division position or size.

Step 101: The transcoder performs inverse quantization (IQ1) and inverse discrete cosine transform (IDCT) on the I, P, and B blocks in the decoded bit stream, performs motion compensation on the corresponding P and B blocks according to the MVs obtained from the P and B blocks, and then generates a complete video data stream according to the corresponding I block. This process is also called decompression.

Step 102: The transcoder maps the MVs obtained from the P and B blocks according to the target compression protocol, that is, performs MV mapping. MV mapping may modify an original MV to a target MV defined in the target compression protocol.

Step 103: The transcoder performs DCT and quantization (Q2) on the complete video data stream according to the target compression protocol. Then the transcoder backs up the P and B blocks, performs IQ2 and IDCT on the P and B blocks backed up, and then combines the corresponding MVs of the P and B blocks to perform motion compensation on the subsequent video data stream. This process is also called compression.

Step 104: The transcoder performs variable length coding (VLC) on the compressed bit stream including the I, P, and B blocks, generates a corresponding output bit stream, and then outputs the bit stream.

In the preceding process, when obtaining MVs of unit image blocks and performing MV mapping, the transcoder needs to perform huge calculation. In certain scenarios, the calculation workload in this step even occupies over 50% of the calculation workload of the entire process, which affects real-time image transmission. Therefore, a research on image coding may be focused on decreasing the calculation workload of obtaining target MVs to ensure real-time image transmission.

In addition, in the prior art, certain coding and decoding protocols already add the predictive mode information of the I block to compress the video data contained in the I block, which greatly increases the compression rate of video data. When processing the input bit streams that contain predictive mode information, however, the prior art transcoder cannot reuse the predictive mode information in the bit streams. This wastes information and increases the calculation workload, thus affecting the transcoding efficiency of the transcoder.

### SUMMARY

Embodiments disclosed herein may provide a method and apparatus for video transcoding to avoid a problem in the prior art that images cannot be transmitted in real time due to huge calculation workload when a transcoder performs transcoding.

Embodiments disclosed herein may provide the following technical solution:

A method for transcoding video data may include: performing VLD on an input bit stream and determining a bit stream part that can be transmitted transparently and a bit stream part that cannot be transmitted transparently according to an original compression protocol, a target compression protocol, and relevant bit stream parameters; decompressing the bit stream part that cannot be transmitted transparently according to the original compression protocol and compressing the decompressed bit stream according to the target compression protocol; and combining the bit stream part that can be transmitted transparently and the compressed bit stream part that cannot be transmitted transparently, and performing VLC on the combined bit stream to generate an output bit stream.

A transcoder may include multiple modules, including, for example: a module for performing VLC on an input bit stream; a module for determining a bit stream part that can be transmitted transparently and a bit stream part that cannot be transmitted transparently in a decoded bit stream according to an original compression protocol, a target compression protocol, and relevant bit stream parameters; a module for decompressing the bit stream part that cannot be transmitted transparently according to the original compression protocol; a module for compressing the decompressed bit stream according to the target compression protocol; a module for combining the bit stream part that can be transmitted transparently and the compressed bit stream part that cannot be transmitted transparently; and a module for performing VLC on the combined bit stream to generate an output bit stream.

A method for transcoding video data may include: performing VLD on an input bit stream and obtaining predictive mode information of an I block and MVs of a P block and a B block; decompressing a corresponding bit stream part according to an original compression protocol and the obtained predictive mode information and MVs, and mapping the predictive mode information and the MVs according to a target compression protocol; and compressing the decompressed bit stream according to the target compression protocol and the mapped predictive mode information and MVs, and performing VLC on the compressed bit stream to generate an output bit stream.

A transcoder may include multiple modules, including, for example: a module for performing VLD on an input bit stream; a module for obtaining predictive mode information of an I block and MVs of a P block and a B block; a module for decompressing a corresponding bit stream part according to an original compression protocol and the obtained predictive mode information and MVs; a module for mapping the predictive mode information and the MVs according to a target compression protocol; a module for compressing the decompressed bit stream according to the target compression protocol and the mapped predictive mode information and MVs; and a module for performing VLC on the compressed bit stream to generate an output bit stream.

A method for transcoding video data may include: performing VLD on several input bit streams respectively and determining bit streams that can be transmitted transparently and bit streams that cannot be transmitted transparently according to a bandwidth bit rate of each input bit stream and a bandwidth bit rate of corresponding output bit stream parts; compressing the bit streams that cannot be transmitted transparently according to the bandwidth bit rate of the corresponding output bit stream parts; and combining the bit streams that can be transmitted transparently and the compressed bit streams that cannot be transmitted transparently, and performing VLC on the combined bit stream to generate an output bit stream.

A transcoder may include multiple module, including, for example: a module for performing VLD on several input bit streams respectively; a module for determining bit streams that can be transmitted transparently and bit streams that cannot be transmitted transparently in the several bit streams according to a bandwidth bit rate of each input bit stream and a bandwidth bit rate of corresponding output bit stream parts; a module for compressing the bit streams that cannot be transmitted transparently according to the bandwidth bit rate of the corresponding output bit stream parts; a module for combining the bit streams that can be transmitted transparently and the compressed bit streams that cannot be transmitted transparently; and a module for performing VLC on the combined bit stream to generate an output bit stream.

In some embodiments, the transcoder transcodes one or more input bit streams by transparently transmitting a part of the input bit streams. This greatly decreases the calculation workload of the transcoder under specified conditions and may better ensure real-time image transmission. In addition, other embodiments may transcode the input bit streams that contain predictive mode information, thus greatly decreasing the calculation workload of the transcoder and improving the working efficiency of the transcoder.

### BRIEF DESCRIPTION OF THE DRAWINGS

FIG. 1 shows a functional structure of a transcoder in the prior art;

FIG. 2 shows an exemplary functional structure of a first transcoder consistent with some embodiments of the present disclosure;

FIG. 3 shows an exemplary flowchart of a first method for a transcoder to transcode video data consistent with some embodiments of the present disclosure;

FIG. 4 shows an exemplary flowchart of a second method for a transcoder to transcode video data consistent with some embodiments of the present disclosure; and

FIG. 5 shows an exemplary functional structure of a second transcoder consistent with some embodiments of the present disclosure.

### DETAILED DESCRIPTION

Embodiments disclosed herein may transcode one or more input bit streams, Sins, by transparently transmitting a part of the bit streams. In addition, if a unit image block in an input bit stream contains predictive mode information, the transcoder obtains and maps the predictive mode information to transcode the input bit stream.

The present embodiments are hereafter described in detail with reference to exemplary embodiments and accompanying drawings.

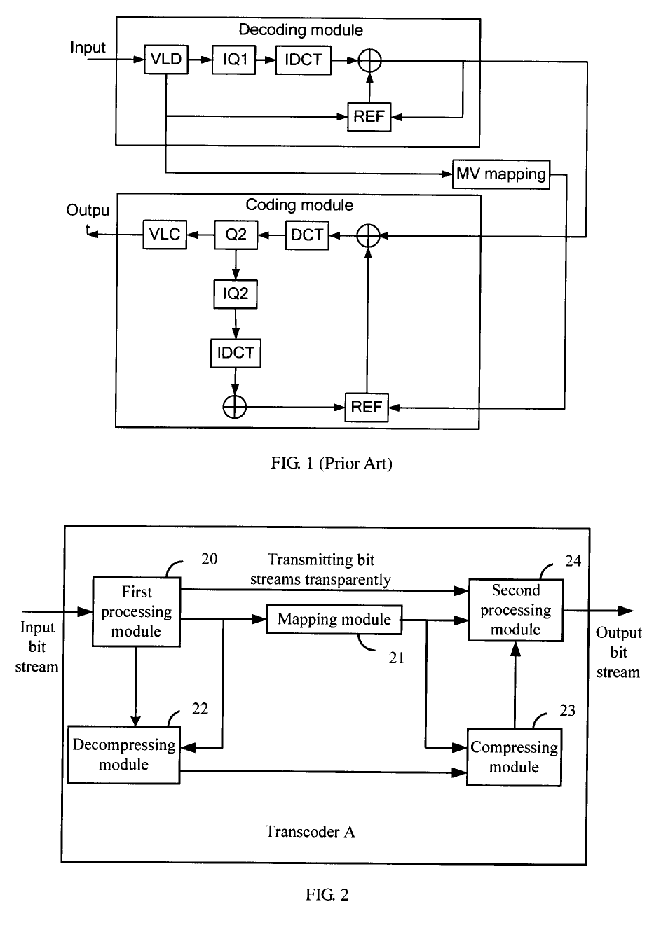

As shown in FIG. 2, transcoder A may include a first processing module 20, a mapping module 21, a decompressing module 22, a compressing module 23, and a second processing module 24.

The first processing module 20 is adapted to: perform VLD on an input bit stream; determine the bit stream part that can be transmitted transparently and the bit stream part that cannot be transmitted transparently in the decoded bit stream according to the original compression protocol; target compression protocol, and relevant bit stream parameters; and obtain the predictive mode information in the I block and the MVs in the P and B blocks from the bit stream part that cannot be transmitted transparently.

Mapping module 21 is adapted to map the obtained predictive mode information in the I block and the MVs in the P and B blocks according to the target compression protocol.

Decompressing module 22 is adapted to decompress the corresponding bit stream part according to the original compression protocol and the obtained predictive mode information and MVs.

Compressing module 23 is adapted to compress the decompressed bit stream according to the target compression protocol and the mapped predictive mode information and MVs.

Second processing module 24 is adapted to combine the bit stream part that can be transmitted transparently and the compressed bit stream part that cannot be transmitted transparently, and perform VLC on the combined bit stream to generate an output bit stream.

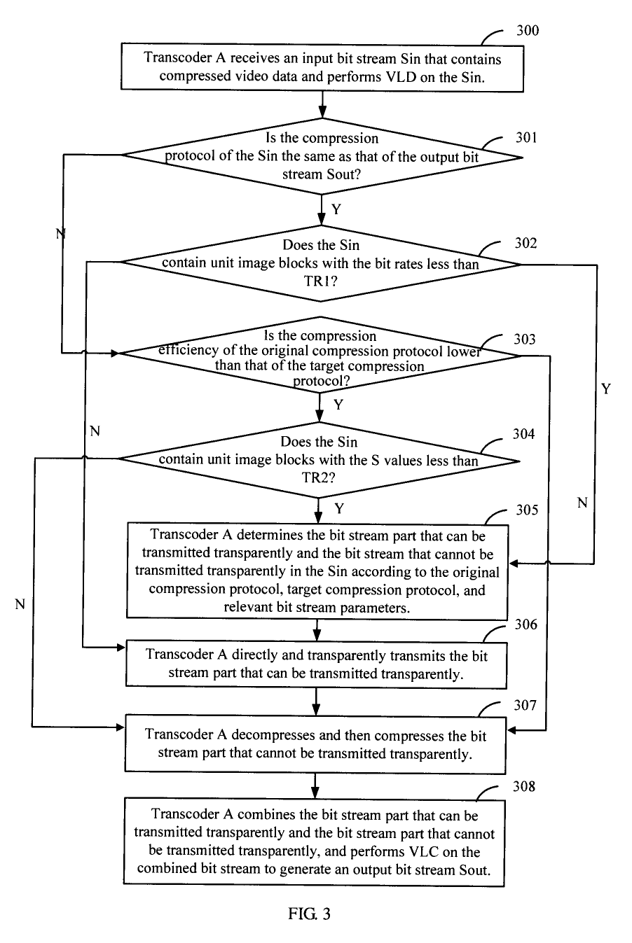

Based on the network architecture shown in FIG. 3, transcoder A consistent with some embodiments may transcode an input bit stream, Sin, by transparently transmitting a part of the bit stream. The specific steps may include the following:

Step 300: Transcoder A receives a Sin that contains compressed video data and performs VLD on the Sin.

Step 301: Transcoder A determines whether the compression protocol of the Sin (that is, the original compression protocol) is the same as that of the output bit stream Sout (that is, the target compression protocol). If yes, transcoder A proceeds to step 302; otherwise, transcoder A proceeds to step 303.

Step 302: Transcoder A further determines whether the decoded Sin contains unit image blocks (including the I, P, and B blocks) whose bit rates are less than the threshold TR1 that is set based on a setting from a computing device or a user according to the Sout. If yes, transcoder A proceeds to step 305. Otherwise, transcoder A determines that the entire Sin cannot be transmitted transparently and proceeds to step 306.

Step 303: Transcoder A further determines whether the compression efficiency of the original compression protocol is lower than that of the target compression efficiency. If yes, transcoder A proceeds to step 304. Otherwise, transcoder A determines that the entire Sin cannot be transmitted transparently and proceeds to step 307.

Step 304: Transcoder A calculates the ratio (called S value) of the bit rate of each unit image block in the decoded Sin to the bit rate of the Sout and determines whether the S values are less than the threshold TR2 that is set by technical engineers according to experiment data. If yes, transcoder A proceeds to step 305. Otherwise, transcoder A determines that the entire Sin cannot be transmitted transparently and proceeds to step 307.

Step 305: Transcoder A determines the bit stream part that contains unit image blocks whose bit rates are less than TR1 in the decoded Sin as the bit stream part that can be transmitted transparently, or determines the bit stream part that contains unit image blocks whose S values are less than TR2 in the decoded Sin as the bit stream part that can be transmitted transparently. Meanwhile, transcoder A determines the bit stream part containing unit image blocks that fail to meet the conditions as the bit stream part that cannot be transmitted transparently.

Step 306: Transcoder A directly and transparently transmits the bit stream part that can be transmitted transparently. That is, transcoder A directly uses the bit stream part that can be transmitted transparently to generate a Sout, without decompressing and recompressing the bit stream part.

The bit stream part that can be transmitted transparently may include the I, P, and B blocks. The corresponding MVs of the P and B blocks are transparently transmitted. Therefore, the MVs can be directly used and do not need to be mapped. In the same way, if the I block contains corresponding predictive mode information, the predictive mode information can also be used directly and does not need to be mapped.

Step 307: Transcoder A obtains the bit stream part that cannot be transmitted transparently in the decoded Sin, including the I, P, and B blocks, obtains the MVs contained in the bit stream part, and then maps the MVs according to the original and target compression protocols. Meanwhile, transcoder A decompresses the corresponding P and B blocks in the bit stream part according to the original compression protocol and the obtained MVs and then compresses the decompressed P and B blocks according to the target compression protocol and the mapped MVs.

Transcoder A also may determine whether the I block in the bit stream part that cannot be transmitted transparently contains corresponding predictive mode information. If the I block does not contain predictive mode information, that is, the video data carried by the I block is not compressed, transcoder A directly compresses the I block according to the target compression protocol. If the I block contains the corresponding predictive mode information, transcoder A obtains the predictive mode information, maps the predictive mode information according to the target compression protocol, decompresses the I block according to the original compression protocol and the obtained predictive mode information, and compresses the decompressed I block according to the target compression protocol and the mapped predictive mode information.

Step 308: Transcoder A combines the bit stream part that is transmitted transparently and the bit stream part that is decompressed and compressed and performs VLC on the combined bit stream to generate a Sout.

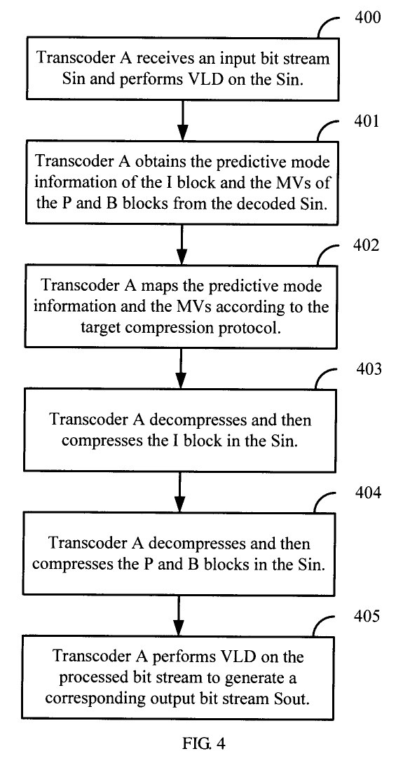

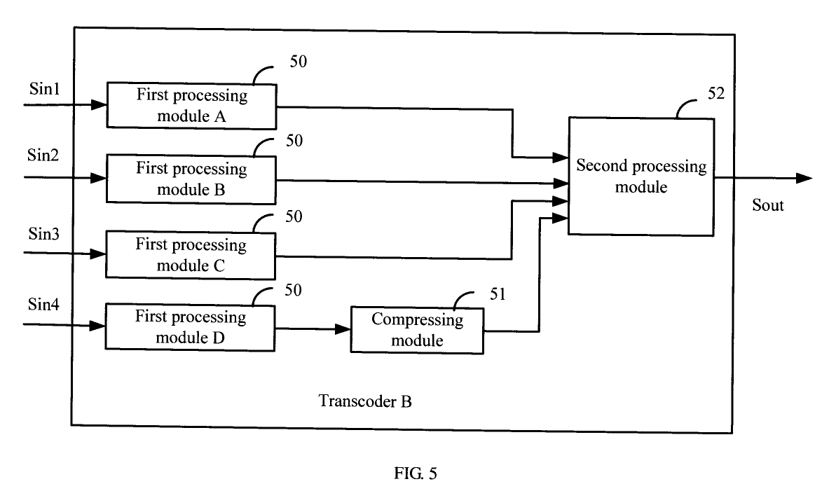

According to the preceding embodiment, in addition to transparently transmitting a part of the bit stream, transcoder A may also transcode the Sin that contains predictive mode information in another way. As shown in FIG. 4, the detailed steps for transcoder A to transcode the Sin that contains the predictive mode information of the I block may include the following:

Step 400: Transcoder A receives a Sin and performs VLD on it.

Step 401: Transcoder A obtains the predictive mode information of the I block and the MVs of the P and B blocks from the decoded Sin.

Step 402: Transcoder A maps the predictive mode information and the MVs according to a target compression protocol.

Step 403: Transcoder A decompresses the I block in the bit stream according to the original compression protocol and the obtained predictive mode information and then compresses the decompressed I block according to the target compression protocol and the mapped predictive mode information.

Step 404: Transcoder A decompresses the P and B blocks in the bit stream according to the original compression protocol and the obtained MVs and then compresses the decompressed P and B blocks according to the target compression protocol and the mapped MVs.

Step 405: Transcoder A performs VLD on the processed bit stream to generate a corresponding Sout.

In the preceding two embodiments, transcoder A shown in FIG. 2 can transcode only separate Sins. In this embodiment, however, another transcoder B can transcode several Sins that are input at the same time. As shown in FIG. 5, transcoder B may include a first processing module 50, a compressing module 51, and a second processing module 52.

The first processing module 50 is adapted to perform VLD on Sin1, Sin2, Sin3, and Sin4 respectively and determine the bit streams that can be transmitted transparently and the bit streams that cannot be transmitted transparently according to the bandwidth bit rate of each Sin and the bandwidth bit rate of corresponding Sout parts.

The compressing module 51 is adapted to compress the bit streams that cannot be transmitted transparently according to the bandwidth bit rate of corresponding Sout parts.

The second processing module 52 is adapted to combine the bit streams that can be transmitted transparently and the compressed bit streams that cannot be transmitted transparently and perform VLC on the combined bit stream to generate a Sout.

In this embodiment, when receiving several Sins, transcoder B may classify the Sins according to a rule and then process the Sins differently according to the types, thus minimizing the calculation workload.

For example, there are four input bit streams in the CIF format: Sin1, Sin2, Sin3, and Sin4. Each having a bandwidth of 512 kbps, 512 kbps, 512 kbps, and 1 Mbps, respectively. The transcoder may present the corresponding video images of these four Sins in one picture. That is, the transcoder may combine the four Sins into one 4-CIF Sout with the bandwidth of 2 Mbps and the compression protocol keeps unchanged. In this case, transcoder B sets the corresponding bandwidths of the four Sins in the Sout to 512 kbps, 512 kbps, 512 kbps, and 512 kbps, respectively. The specific process is as follows:

Firstly, after receiving the four Sins, transcoder B performs VLD on the four Sins, respectively, and then classifies the four Sins into two types according to the bandwidth of each Sin and the bandwidth of corresponding Sout parts: bit stream whose bandwidth is 512 kbps, including Sin1, Sin2, and Sin3; and bit stream whose bandwidth is not 512 kbps, including Sin4. Secondly, transcoder B transmits Sin1, Sin2, and Sin3 directly and transparently. That is, transcoder B directly reuses the information in the three bit streams to generate a Sout. Meanwhile, transcoder B decreases the rate of only Sin4 with a bandwidth of 1 Mbps. That is, transcoder B compresses Sin4 according to the bandwidth of the corresponding Sout and converts the bandwidth of Sin4 into 512 kbps. Finally, transcoder B combines Sin1, Sin2, and Sin3 that are transparently transmitted and Sin4 whose rate is decreased and performs VLC on the combined bit stream to generate a 4-CIF Sout with the bandwidth of 2 Mbps.

In summary, disclosed embodiments herein transcode one or more input bit streams by transparently transmitting a part of the input bit streams. This may greatly decrease the calculation workload of the transcoder under specified conditions and better ensure real-time image transmission. In addition, some embodiments transcode the input bit streams that contain predictive mode information, thus greatly decreasing the calculation workload of the transcoder and improving the working efficiency of the transcoder.

It is apparent that those skilled in the art can make various modifications and variations to the invention without departing from the spirit and scope of the invention. The present invention is intended to cover these modifications and variations provided that they fall in the scope of protection defined by the following claims or their equivalents.

What is claimed is:

1. A method for transcoding video data, comprising:
decoding an input bit stream and determining a bit stream part that can be transmitted transparently and a bit stream part that cannot be transmitted transparently in the decoded bit stream;
decompressing the bit stream part that cannot be transmitted transparently according to an original compression protocol and compressing the decompressed bit stream according to a target compression protocol; and
combining the bit stream part that can be transmitted transparently and the compressed bit stream part that cannot be transmitted transparently and performing variable length coding on the combined bit stream to generate an output bit stream.

2. The method of claim 1, comprising: performing variable length decoding on the input bit stream; and performing variable length coding on the combined bit stream.

3. The method of claim 2, comprising: determining the bit stream part that can be transmitted transparently and the bit stream part that cannot be transmitted transparently in the decoded bit stream according to the original compression protocol, the target compression protocol, and relevant bit stream parameters.

4. The method of claim 3, comprising:
if the original compression protocol is the same as the target compression protocol, determining a bit stream part that contains unit image blocks whose bit rates are less than a threshold as the bit stream part that can be transmitted transparently and determining a bit stream part that contains unit image blocks whose bit rates are not less than the threshold as the bit stream part that cannot be transmitted transparently; or
if the original compression protocol is different from the target compression protocol and a compression efficiency of the original compression protocol is lower than that of the target compression protocol, calculating a ratio of the bit rate of each unit image block to a target bit rate, determining a bit stream part that contains unit image blocks whose ratios are less than a threshold as the bit stream part that can be transmitted transparently, and determining a bit stream part that contains unit image blocks whose ratios are not less than the threshold as the bit stream part that cannot be transmitted transparently.

5. The method of claim 4, wherein:
if an image block in a key video frame in the bit stream contains predictive mode information when processing the bit stream part that cannot be transmitted transparently, the method further comprises:
obtaining the predictive mode information; mapping the predictive mode information according to the target compression protocol; decompressing the image block in the key video frame according to the original compression protocol and the obtained predictive mode information; and compressing the decompressed image block in the key video frame according to the target compression protocol and the mapped predictive mode information.

6. A transcoder, comprising:
a module for encoding an input bit stream;
a module for determining a bit stream part that can be transmitted transparently and a bit stream part that cannot be transmitted transparently in a decoded bit stream;
a module for decompressing the bit stream part that cannot be transmitted transparently according to an original compression protocol;
a module for compressing the decompressed bit stream according to a target compression protocol;
a module for combining the bit stream part that can be transmitted transparently and the compressed bit stream part that cannot be transmitted transparently; and
a module for encoding the combined bit stream to generate an output bit stream.

7. The transcoder of claim 6, wherein:
after performing variable length decoding on the input bit stream, the transcoder further determines whether the original compression protocol of the bit stream is the same as the target compression protocol of the bit stream;
if the original compression protocol is the same as the target compression protocol, the transcoder determines a bit stream part that contains unit image blocks whose bit rates are less than a threshold as the bit stream part that can be transmitted transparently and determines a bit stream part that contains unit image blocks whose bit rates are not less than the threshold as the bit stream part that cannot be transmitted transparently; and
if the original compression protocol is different from the target compression protocol and a compression efficiency of the original compression protocol is lower than that of the target compression protocol, the transcoder calculates a ratio of the bit rate of each unit image block to a target bit rate, determines a bit stream part that contains unit image blocks whose ratios are less than a threshold as the bit stream part that can be transmitted transparently and determines a bit stream part that contains unit image blocks whose ratios are not less than the threshold as the bit stream part that cannot be transmitted transparently.

8. The transcoder of claim 6, wherein:
when processing the bit stream part that cannot be transmitted transparently, if an image block in a key video frame in the bit stream contains predictive mode information, the transcoder obtains the predictive mode information, maps the predictive mode information according to the target compression protocol, decompresses the image block in the key video frame according to the original compression protocol and the obtained predictive mode information, and compresses the decompressed image block in the key video frame according to the target compression protocol and the mapped predictive mode information.

9. A method for transcoding video data, comprising:
performing variable length decoding on an input bit stream and obtaining predictive mode information of an image block in a key video frame and motion vectors of image blocks in a predictive video frame;
decompressing a corresponding bit stream part according to an original compression protocol and the obtained predictive mode information and motion vectors, and mapping the predictive mode information and the motion vectors according to a target compression protocol; and
compressing the decompressed bit stream according to the target compression protocol and the mapped predictive mode information and motion vectors and performing variable length coding on the compressed bit stream to generate an output bit stream.

10. The method of claim 9, wherein after performing variable length decoding on the input bit stream, the method further comprises:
if the original compression protocol is the same as the target compression protocol, determining a bit stream part that contains unit image blocks whose bit rates are less than a threshold as the bit stream part that can be transmitted transparently and a bit stream part that contains unit image blocks whose bit rates are not less than the threshold as the bit stream part that cannot be transmitted transparently; or
if the original compression protocol is different from the target compression protocol and the compression efficiency of the original compression protocol is lower than that of the target compression protocol, calculating a ratio of the bit rate of each unit image block to a target bit rate, determining a bit stream part that contains unit image blocks whose ratios are less than a threshold as the bit stream part that can be transmitted transparently and determining a bit stream part that contains unit image blocks whose ratios are not less than the threshold as the bit stream part that cannot be transmitted transparently.

11. The method of claim 10, comprising: decompressing the bit stream part that cannot be transmitted transparently according to the original compression protocol; compressing the decompressed bit stream according to the target compression protocol; combining the bit stream part that can be transmitted transparently and the compressed bit stream part that cannot be transmitted transparently; and performing variable length coding on the combined bit stream to generate an output bit stream.

12. A transcoder, comprising:
a module for performing variable length decoding on an input bit stream;
a module for obtaining predictive mode information of an image block in a key video frame and motion vectors of image blocks in a predictive video frame;
a module for decompressing a corresponding bit stream part according to an original compression protocol and the obtained predictive mode information and motion vectors;
a module for mapping the predictive mode information and the motion vectors according to a target compression protocol;
a module for compressing the decompressed bit stream according to the target compression protocol and the mapped predictive mode information and motion vectors; and
a module for performing variable length coding on the compressed bit stream to generate an output bit stream.

13. A method for transcoding video data, comprising:
performing variable length decoding on several input bit streams respectively and determining bit streams that can be transmitted transparently and bit streams that cannot be transmitted transparently according to a bandwidth bit rate of each input bit stream and a bandwidth bit rate of corresponding output bit stream parts;
compressing the bit streams that cannot be transmitted transparently according to the bandwidth bit rate of the corresponding output bit stream parts; and
combining the bit streams that can be transmitted transparently and the compressed bit streams that cannot be transmitted transparently and performing variable length coding on the combined bit stream to generate an output bit stream.

14. A transcoder, comprising:
a module for performing variable length decoding on several input bit streams respectively;
a module for determining bit streams that can be transmitted transparently and bit streams that cannot be transmitted transparently in the several bit streams according to a bandwidth bit rate of each input bit stream and a bandwidth bit rate of corresponding output bit stream parts;
a module for compressing the bit streams that cannot be transmitted transparently according to the bandwidth bit rate of the corresponding output bit stream parts;
a module for combining the bit streams that can be transmitted transparently and the compressed bit streams that cannot be transmitted transparently; and
a module for performing variable length coding on the combined bit stream to generate an output bit stream.
